(19) United States
(12) Patent Application Publication
(10) Pub. No.: US 2010/0206611 A1
(43) Pub. Date: Aug. 19, 2010

(54) INSULATING VARNISH AND INSULATED WIRE

(75) Inventors: Yuki HONDA, Hitachi (JP); Tomiya Abe, Hitachi (JP)

Correspondence Address: FOLEY AND LARDNER LLP;SUITE 500, 3000 K STREET NW, WASHINGTON, DC, 20007, US

(73) Assignee: HITACHI CABLE, LTD.

(21) Appl. No.: 12/541,458

(22) Filed: Aug. 14, 2009

(30) Foreign Application Priority Data
Feb. 17, 2009 (JP) 2009-034250

(51) Int. Cl. H01B 3/30; C08G 69/26; B32B 27/34

(52) U.S. Cl. 174/110 SR; 528/353; 428/395

(57) ABSTRACT

An insulating varnish for forming an insulating covering on a conductor includes a polyimide resin including a repeat unit represented by a general formula (1):

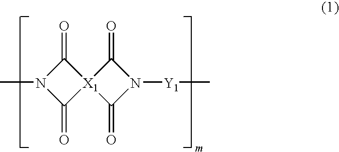

where X₁ includes a tetravalent aromatic group including an aromatic ether structure represented by a formula (3):

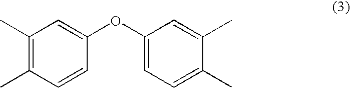

and Y₁ includes a bivalent aromatic group including an aromatic ether structure, and a repeat unit represented by a general formula (2):

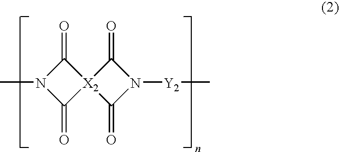

where X₂ includes a tetravalent alicyclic group and Y₂ includes a bivalent alicyclic group including an alicyclic structure.

The present application is based on Japanese patent application No. 2009-034250 filed Feb. 17, 2009, the entire contents of which are incorporated herein by reference.

### BACKGROUND OF THE INVENTION

1. Field of the Invention

This invention relates to an insulating varnish and an insulated wire and, in particular, to a polyimide resin insulating varnish and an insulated wire using the polyimide resin insulating varnish.

2. Description of the Related Art

In recent years, as electrical equipments are downsized and enhanced in performance, some electrical equipments inverter-controlled at high voltage have been developed. When electrical equipment is inverter-controlled, an inverter surge voltage may occur thereby and penetrate into the electrical equipment. In this case, partial discharge may occur in an insulated wire of the electrical equipment such that an insulating covering of the insulated wire deteriorates.

To solve the problem, an insulating varnish formed of fluorine system polyimide resin is proposed which is used for forming an insulating covering on the surface of a conductor by being coated and then baked (See JP-A-2002-56720). JP-A-2002-56720 teaches an insulating varnish produced by using a specific fluorine system polyimide resin to have a reduced specific dielectric constant. Thereby, the deterioration resistance of the insulating covering can be enhanced even when a high radiofrequency voltage is applied thereto.

However, the insulating varnish of JP-A-2002-56720 has the following problem. The insulating covering formed of fluorine system polyimide resin is low in adhesion to the conductor although the fluorine system polyimide resin contributes to lowering the dielectric constant of the insulating covering. Therefore, the insulating covering may be separated from the conductor such that a gap occurs between the conductor and the insulating covering. This causes a dielectric breakdown.

### SUMMARY OF THE INVENTION

It is an object of the invention to provide an insulating varnish that can produce an insulating covering with a high adhesion to a conductor, a reduced dielectric constant as well as a sufficient heat resistance.
(1) According to one embodiment of the invention, an insulating varnish for forming an insulating covering on a conductor comprises:

a polyimide resin comprising:

a repeat unit represented by a general formula (1):

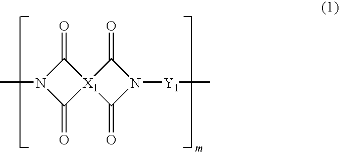

where X₁ comprises a tetravalent aromatic group comprising an aromatic ether structure represented by a formula (3):

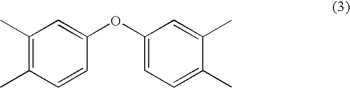

and Y₁ comprises a bivalent aromatic group comprising an aromatic ether structure; and

a repeat unit represented by a general formula (2):

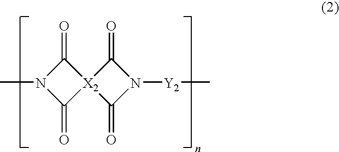

where X₂ comprises a tetravalent alicyclic group and Y₂ comprises a bivalent alicyclic group comprising an alicyclic structure,

wherein, in the general formulas (1) and (2), m and n each are the number of repeat units and a positive integer.

In the above embodiment (1), the following modifications, changes and a combination thereof can be made.

(i) X₂ in the general formula (2) comprises a tetravalent alicyclic group selected from groups represented by formulas (4) to (6) below.

Y₁ in the general formula (1) comprises a bivalent aromatic group comprising an aromatic ether structure and represented by a formula (7) below, where 1≦p≦5, and

Y₂ in the general formula (2) comprises a bivalent alicyclic group comprising an alicyclic structure and represented by a formula (8) or (9) below.

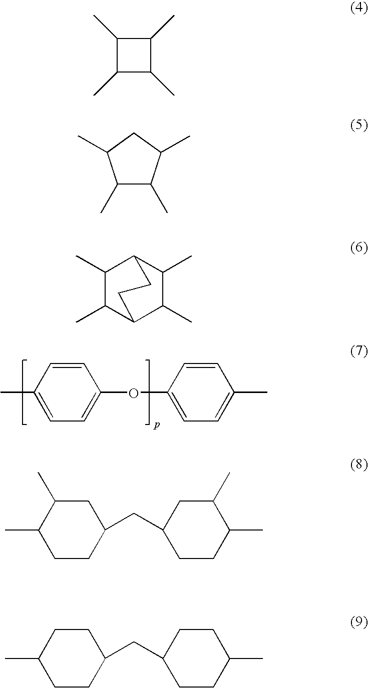

(ii) The polyimide resin comprises a ratio of the number m of repeat units represented by the general formula (1) to the number n of repeat units represented by the general formula (2): 1/3≦m/n<3.
(2) According to another embodiment of the invention, an insulated wire comprises:

an insulating covering formed by coating and baking an insulating varnish on a conductor,

wherein the insulating varnish comprises:

a polyimide resin comprising:

a repeat unit represented by a general formula (1):

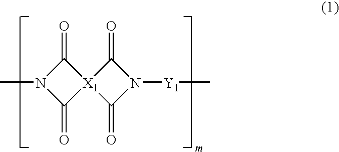

where X₁ comprises a tetravalent aromatic group comprising an aromatic ether structure represented by a formula (3):

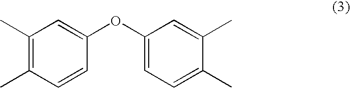

and Y₁ comprises a bivalent aromatic group comprising an aromatic ether structure: and

a repeat unit represented by a general formula (2):

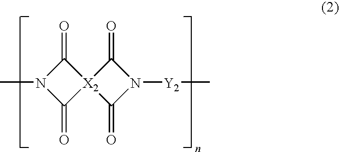

where X₂ comprises a tetravalent alicyclic group and Y₂ comprises a bivalent alicyclic group comprising an alicyclic structure,

wherein, in the general formulas (1) and (2), m and n each are the number of repeat units and a positive integer.

In the above embodiment (2), the following modifications, changes and a combination thereof can be made.

(iii) X₂ in the general formula (2) comprises a tetravalent alicyclic group selected from groups represented by formulas (4) to (6) below,

Y₁ in the general formula (1) comprises a bivalent aromatic group comprising an aromatic ether structure and represented by a formula (7) below, where 1≦p≦5, and

Y₂ in the general formula (2) comprises a bivalent alicyclic group comprising an alicyclic structure and represented by a formula (8) or (9) below.

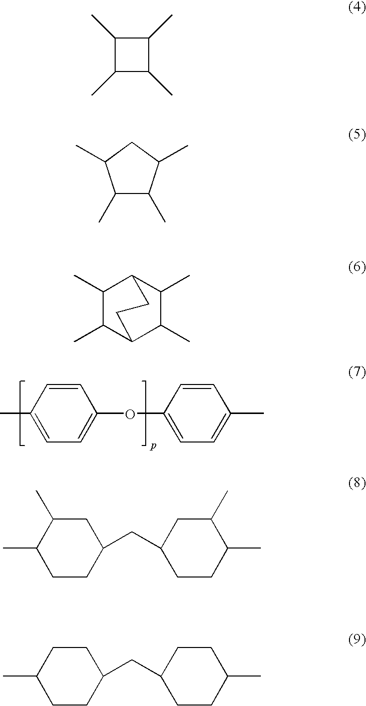

(iv) The insulated wire further comprises:

an intermediate insulating covering formed between the conductor and the insulating covering.

(v) The intermediate insulating covering is formed by coating and baking a silane coupling agent on a surface of the conductor.

Points of the Invention

According to one embodiment of the invention, an insulating varnish and an insulating covering is formed of a polyimide resin including a group X₁ as represented by the formula (3) and a group Y₁ as represented by the formula (7) that are an aromatic group with an aromatic ether structure. In the aromatic ether structure, the existing probability of conjugate π electron is lowered at the site of oxygen atom, where flow of electrons is likely to be interrupted. Thus, the introduction of the group represented by the formula (3) or (7) into the polyimide resin allows a reduction in charge polarization in the polyimide resin, so that the dielectric constant of the insulating covering can be reduced,

### BRIEF DESCRIPTION OF THE DRAWINGS

The preferred embodiments according to the invention will be explained below referring to the drawings, wherein:

FIG. 1A is a cross sectional view showing an insulated wire in a preferred embodiment according to the invention:

FIG. 1B is a cross sectional view showing an insulated wire in a modification of the embodiment according to the invention; and

FIG. 2 is a cross sectional view showing an insulated wire in another modification of the embodiment according to the invention.

### DETAILED DESCRIPTION OF THE PREFERRED EMBODIMENTS

### Embodiments

Insulating Varnish

An insulating varnish in the embodiment of the invention is used to form a insulating covering for covering a conductor of a metal material such as oxygen-free copper and copper, and is formed of a polyimide resin composed of a repeat unit represented by a general formula (1) below and a repeat unit represented by a general formula (2) below.

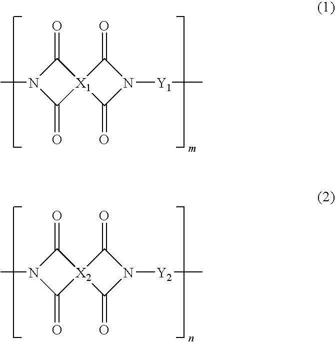

For example, the insulating varnish of the embodiment can be formed of a polyimide resin represented by a general formula (10) below and composed of the general formula (1) and the general formula (2).

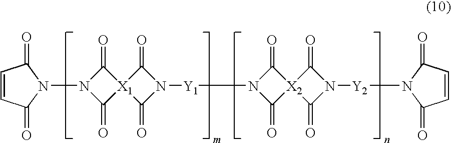

The general formula (10) represents a polyimide resin as a block copolymer that includes the repeat unit of the general formula (1) and the repeat unit of the general formula (2). Alternatively, the insulating varnish of the embodiment can be formed of a polyimide resin as an alternating copolymer or a random copolymer that includes the repeat unit of the general formula (1) and the repeat unit of the general formula (2).

In the general formula (1). X₁ represents a tetravalent aromatic group with an aromatic ether structure. In the general formula (1), Y₁ represents a bivalent aromatic group with an aromatic ether structure. On the other hand, in the general formula (2). X₂ represents a tetravalent alicyclic group, and Y₂ represents a bivalent alicyclic group including one or more alicyclic structures. In the general formulas (1). (2), in and n each are the number of repeat units and a positive integer.

In more detail, X₁ may be a group represented by a formula (3) below. The tetravalent aromatic group X₁ with an aromatic ether structure may be a group derived from, e.g., 4,4′-oxydiphthalic acid dianhydride (ODPA) etc.

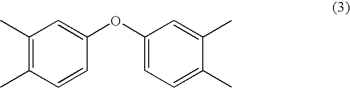

In the general formula (1), Y₁ may be a bivalent aromatic group represented by a formula (7) below and with an aromatic ether structure of 1≦p≦5. The bivalent aromatic group Y₁ with an aromatic ether structure may be a group derived from, e.g., 1,4-bis(4-aminophenoxy)benzene (TPE-Q), 3,4′-diaminodiphenylether (m-DDE), 4,4′-diaminodiphenylether (p-DDE), 1,3-bis(3-aminophenoxy benzene) (APB), 9,9-bis(4-aminophenyl)fluorene 2,2-bis[4-(4-aminophenoxy)phenyl]propane etc.

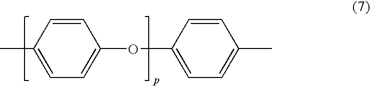

In the general formula (2), X₂ may be at least one tetravalent alicyclic group selected from the group consisting of a formula (4) below, a formula (5) below and a formula (6) below.

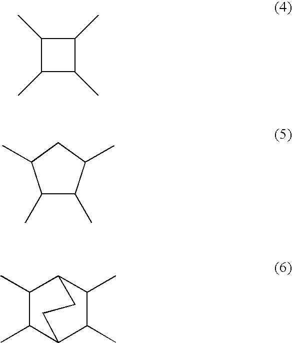

In the general formula (2), Y₂ may be a bivalent alicyclic group with an alicyclic structure represented by a formula (8) below, or a bivalent alicyclic group with an alicyclic structure represented by a formula (9) below. The group represented by the formula (8) has two binding sites with the other skeleton.

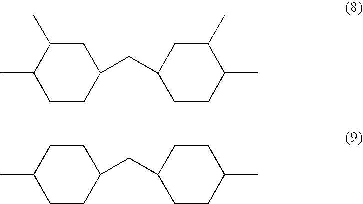

Details of General formula (1)

In the general formula (1), X₁ as represented by the formula (3) is a tetravalent aromatic group with an aromatic ether structure that is a non-condensed polycyclic aromatic group in which aromatic groups are combined each other via a cross-linking element. The existing probability of conjugate π electron is lowered at the site of oxygen atom, where flow of electrons is likely to be interrupted. Thus, the introduction of the group represented by the formula (3) into the general formula (1) allows a reduction in charge polarization in the compound (e.g., the compound represented by the general formula (10)) composed of the general formula (1) and the general formula (2), so that the dielectric constant of the insulating covering in the embodiment can be reduced.

When the insulating covering formed of the insulating varnish in the embodiment is exposed to high temperature of 250° C. or more, the elasticity of the insulating covering lowers. As the elasticity lowers, the heat resistance of the insulating covering lowers. In order to prevent the lowering of the heat resistance, the amount of the aromatic ether structures (i.e., the group represented by the formula (3)) introduced into the compound composed of the general formula (1) and the general formula (2) is preferably less than a predetermined amount.

On the other hand, the bivalent aromatic group Y₁ with the aromatic ether structure that is introduced into the compound represented by the general formula (1) and is represented by the general formula (7) is likely to interrupt flow of electrons as in the formula (3) since it includes the aromatic ether structure therein. As the amount of the group represented by the general formula (7) in the compound composed of the general formula (1) and the general formula (2) increases, charge polarization decreases such that the dielectric constant of the insulating covering in the embodiment can be reduced. Especially, when the number p of repeat units in the general formula (7) is set to be 1≦p≦5, the insulating varnish can provide both the heat resistance and the low dielectric constant of the insulating covering. If a group without the aromatic ether structure is used instead of the group represented by the general formula (7) in the compound represented by the general formula (1), the insulating covering cannot have a sufficient low dielectric constant property. If the number p of repeat units in the general formula (7) is more than 5, the insulating covering may not have a sufficient heat resistance since at 250° C. region the elasticity lowers significantly and the insulating varnish acts as a fluid thermoplastic resin.

Details of General formula (2)

The tetravalent alicyclic group X₂ in the general formula (2) may be a group derived from, e.g., cyclobutanetetracarboxylic acid dianhydride (CBDA), cyclopentanetetracarboxylic acid dianhydride (CPDA), bicyclo(2,2,2)octo-7-ene-2,3,5,6-tetracarboxylic acid dianhydride (BCD), bicyclo(2,2,2)octane-2,3,5,6-tetracarboxylic acid dianhydride (BTA-H) etc. For example, the group represented by the general formula (4) is derived from CBDA, the group represented by the general formula (5) is derived from CPDA, and the group represented by the general formula (6) is derived from BCD or BTA-H.

The bivalent alicyclic group Y₂ (including one or more alicyclic structures) in the general formula (2) may be a group derived from, e.g., 3,3′-dimethyl-4,4′-diaminodicyclohexylmethane (DMHM), 4,4′-diaminodicyclohexylmethane (DAHM) etc. For example, the group represented by the general formula (8) is derived from DMHM, and the group represented by the general formula (9) is derived from DAHM.

The dielectric constant of the compound represented by the general formula (2) can be reduced by using the group X₂ represented by the general formula (4) to the general formula (6) and the group Y₂ represented by the general formula (8) or the general formula (9).

The group X₂ will be detailed below. Since the group X₂ is a tetravalent alicyclic group, the insulating varnish with the group X₂ included therein can be reduced in polymer interaction, e.g., π-π electron overlap between the polymer chains as represented by the general formula (10). In addition, due to the chemical structure of the group X₂, no charge movement occurs on the group X₂. Further, since the group X₂ does not include the aromatic ring, the molecular polarizability as well as the refractive index can be reduced as compared to a group with the aromatic ring. Thus, the dielectric constant of the insulating varnish in the embodiment can be reduced by introducing the group X₂ thereinto since Maxwell's equation is expressed as ε=n² where ε is dielectric constant of a material and n is a refractive index thereof.

Here, when the insulating varnish formed of polyimide resin includes more than a predetermined mount of unsaturated hydrocarbon, the polarity thereof lowers. In this case, when an insulating covering is formed by coating the insulating varnish on a conductor of copper etc., the adhesion of the insulating covering to the copper with a high polarity can be only restrictively improved although the dielectric constant thereof can be reduced. Therefore, in the embodiment, the rate of the group X₂ represented by the general formula (4) to the general formula (6) and the group Y₂ represented by the general formula (8) or the general formula (9) in the general formula (2) is preferably less than a predetermined rate.

Relationship Between the Repeat Unit in the General Formula (1) and the Repeat Unit in the General Formula (2)

In order to provide both the heal resistance and the low dielectric constant property for the insulating covering formed by using the insulating varnish formed of the general formula (1) and the general formula (2), the ratio of the number m of repeat units included in the group represented by the general formula (1) to the number n of repeat units included in the group represented by the general formula (2) is preferably 1/3≦m/n≦3.

Method of Producing the Insulating Varnish

The insulating varnish of the embodiment is synthesized such that plural starting materials are added to a solvent and then reacted under predetermined conditions. The insulating varnish thus synthesized includes resin and solvent.

The solvent may be a sole organic solvent such as N-methyl-2-pyrolidone (NMP), dimethylformamide, dimethylacetamide, sulfolane, anisole, dioxolan, butyl cellosolve acetate, lactone etc. or a mixed solvent thereof.

Insulated Wire

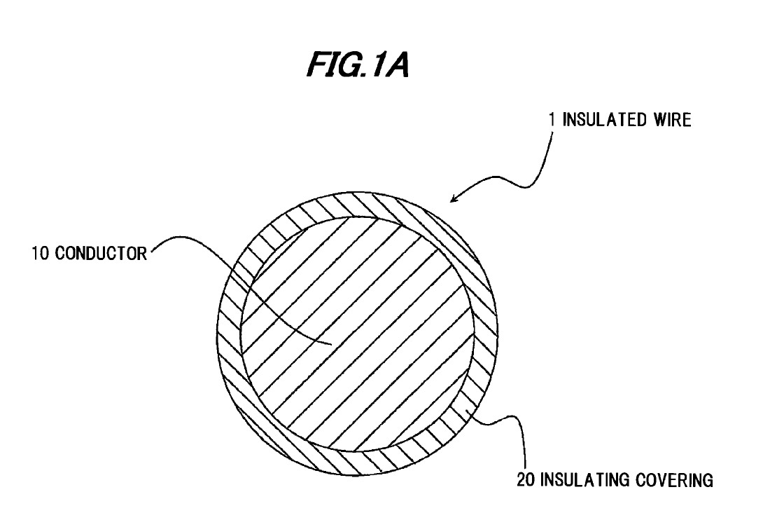

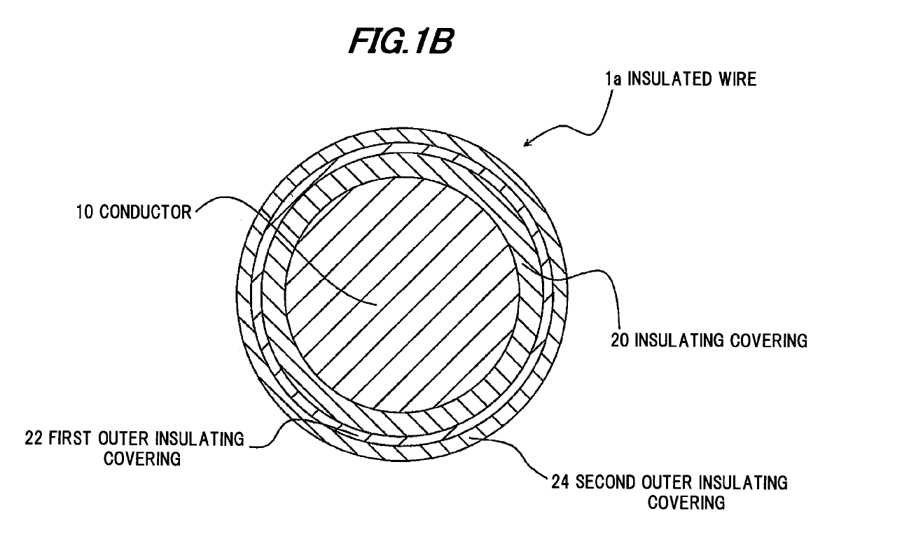

FIG. 1A is a cross sectional view showing an insulated wire in the embodiment of the invention.

The insulated wire 1 of the embodiment is composed of a conductor 10 of a metal material such as oxygen-free copper, copper etc., and an insulating covering 20 for covering the conductor 10. The insulating covering 20 is formed of the insulating varnish in the embodiment. For example, the insulating varnish thus synthesized is coated and baked on the periphery of the conductor 10 to form the insulated wire 1 with the insulating covering 20 formed of the insulated varnish in the embodiment. The insulated wire 1 may further include a self-lubricating insulating covering as an outermost layer. The self-lubricating insulating covering can be formed of an insulating varnish in which a lubricant such as carnauba wax is added to a polyamide resin.

FIG. 1B is a cross sectional view showing an insulated wire in a modification of the embodiment.

The insulated wire 1a in the modification is constructed such that a further insulating covering or multiple insulating coverings are formed on the periphery of the insulated wire 1 as shown in FIG. 1A. For example, in order to the heat resistance of the insulating covering, one or more insulating films may be formed on the insulating covering 20 where the insulating films are formed of polyamide-imide resin, polyimide resin, polyesterimide resin etc. The insulated wire 1a as shown in FIG. 1B is constructed such that a first outer insulating covering 22 is formed on the periphery of the insulating covering 20, and a second outer insulating covering 24 is formed on the periphery of the first outer insulating covering 22. The first outer insulating covering 22 and the second outer insulating covering 24 may include one or more insulating coverings.

Although not shown, a lubricative insulating covering may be further formed on the periphery of the insulating covering 20 so as to enhance the lubricative property. Further, a lubricative insulating covering may be formed on the outermost layer of the insulated wire 1a.

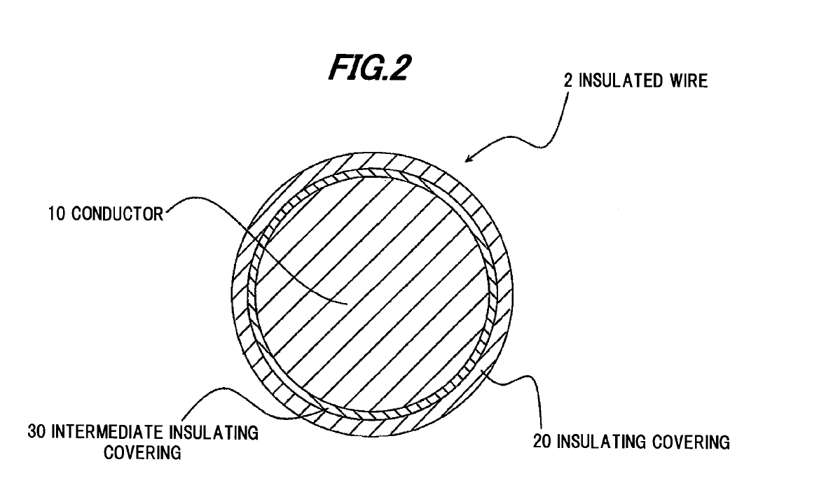

FIG. 2 is a cross sectional view showing an insulated wire in another modification of the embodiment.

In producing the insulated wire 2 in another modification, an intermediate insulating covering 30 of a silane coupling agent may be formed between the conductor 10 and the insulating covering 20 so as to further enhance the adhesion between the conductor 10 and the insulating covering 20. For example, the silane coupling agent is coated and heated on the conductor 10 to form the intermediate insulating covering 30 of the silane coupling agent on the surface of the conductor 10. Then, the insulating varnish of the embodiment is coated and baked on the intermediate insulating varnish 30 to have the insulated wire 2. Similarly to the insulated wire 1, the insulated wire 2 may further have a self-lubricating insulating covering on the outermost layer.

The silane coupling agent may be 3-glycidoxypropyl trimethoxysilane. 3-methacryloxypropyl trimethoxysilane, 3-acryoxypropyl trimethoxysilane, 3-aminopropyl trimethoxysilane, 3-aminopropyl triethoxysilane, N-2-(aminoethyl)-3-aminopropyl trimethoxysilane, 3-mercaptopropyl trimethoxysilane etc.

The insulated wires 1, 1a and 2 in the embodiment can apply to coils used for electrical equipments such as a motor and a transformer. For example, insulated wires 1, 1a and 2 can apply to a coil formed by bonding and connecting the terminals of plural insulated wires each other by welding etc.

### Effects of the Embodiment

The insulating varnish of the embodiment includes the groups represented by the general formulas (3) to (9) as well as the groups represented by the general formula (1) and the general formula (2), so that it can produce an insulating covering with a high adhesion to a conductor, a reduced dielectric constant as well as a sufficient heat resistance of polyimide resin. Thus, the insulating varnish of the embodiment can produce a insulating covering with a high partial discharge inception voltage so as to prevent occurrence of partial discharge and deterioration of the insulating covering due to the partial discharge, so that the lifetime of an inverter-controlled electrical equipment (e.g., a coil for a motor) can be lengthened.

### EXAMPLES

The invention will be further detailed referring to Examples below.

### Example 1

An insulating varnish in Example 1 is synthesized as below.

First, an Allihn condenser tube with a trap equipped with a silicone stop cock is attached to a 51 three-necked separable flask with a stirrer. Then, 125.1 g of bicyclo(2,2,2)octane-2,3,5,6-tetracarboxylic acid dianhydride (BTA-H, MW=250.2). 119.2 g of 3,3′-dimethyl-4,4′-diaminodicyclohexylmethane (DMHM, MW=238.42), and 1466 g of N-methyl-2-pyrolidone (NMP, MW=99.1) are weighed. Then, the weighed materials are put in the flask. Then, stirring at a rotation speed of 180 rpm, they are reacted at 180° C. for 8 hours (First reaction step). Then, 155.1 g of 4,4′-oxydiphthalic acid dianhydride (ODPA, MW=310.21), 100.1 g of 4′-diaminodiphenylether (p-DDE, MW=200.2) and 2041 g of N-methyl-2-pyrolidone are weighed and further put in the flask. Then, stirring at a rotation speed of 180 rpm, they are reacted at room temperature for 5 hours (Second reaction step). Then, 20 g of maleic anhydride is further put in the flask, and they are reacted at room temperature for 5 hours (Third reaction step). Thereby, a polyimide precursor resin as an insulating varnish in Example 1 is produced.

Then, on the surface of a copper conductor with a circular section, 1% aqueous solution of 3-aminopropyl trimethoxysilane (Shin-Etsu Chemical Co., Ltd., KBE-903) is coated (Silane coupling agent coating step). Then, the conductor is put in a far-infrared heater and heated at 100° C. for 5 min (Silane coupling agent heating step). Thereby, a 1 intermediate insulating covering is formed 1 μm thick on the surface of the conductor.

Then, the polyimide precursor resin in Example 1 is coated on the periphery of the intermediate insulating covering. For example, the conductor with the intermediate insulating covering formed thereon is passed through a coating die to coat the polyimide precursor resin in Example 1 thereon (Coating step). Then, baking at 240° C. for 1 min (First baking step), subsequently baking at 340° C. for 1 min (Second baking step), a covering of polyimide resin is formed on the conductor. Then, the coating step, the first baking step and the second baking step are repeated 14 times. Thereby, an insulated wire as an enameled wire in Example 1 is produced in which a 31 μm thick insulating covering is formed on the surface of the conductor.

### Example 2

An insulating varnish in Example 2 is synthesized as in Example 1 except that in the first reaction step, 105 g of 4,4′-diaminodicyclohexylmethane (DAHM, MW=210.4) is added instead of 3,3′-dimethyl-4,4′-diaminodicyclohexylmethane (DMHM). An insulated wire in Example 2 is produced by the same steps as the insulated wire in Example 1 while using the insulating varnish in Example 2.

### Example 3

An insulating varnish in Example 3 is synthesized as in Example 1 except that in the first reaction step, 187.7 g of bicyclo(2,2,2)octane-2,3,5,6-tetracarboxylic acid dianhydride (BTA-H) and 59.6 g of 3,3′-dimethyl-4,4′-diaminodicyclohexylmethane (DMHM) are added and in the second reaction step, 77.6 g of 4,4′-oxydiphthalic acid dianhydride (ODPA), 150.2 g of 4′-diaminodiphenylether (p-DDE) are added. An insulated wire in Example 3 is produced by the same steps as the insulated wire in Example 1 while using the insulating varnish in Example 3.

### Example 4

An insulating varnish in Example 4 is synthesized as in Example 1 except that in the first reaction step. 62.6 g of bicyclo(2,2,2)octane-2,3,5,6-tetracarboxylic acid dianhydride (BTA-H) and 178.9 g of 3,3′-dimethyl-4,4′-diaminodicyclohexylmethane (DMHM) are added and in the second reaction step, 232.7 g of 4,4′-oxydiphthalic acid dianhydride (ODPA), 50.05 g of 4′-diaminodiphenylether (p-DDE) are added. An insulated wire in Example 4 is produced by the same steps as the insulated wire in Example 1 while using the insulating varnish in Example 4.

### Example 5

An insulating varnish in Example 5 is synthesized as in Example 1 except that in the first reaction step, 62.6 g of bicyclo(2,2,2)octane-2,3,5,6-tetracarboxylic acid dianhydride (BTA-H) and 157.8 g of 4,4′-diaminodicyclohexylmethane (DAHM) is added instead of 3,3′-dimethyl-4,4′-diaminodicyclohexylmethane (DMHM) and in the second reaction step, 232.7 g of 4,4′-oxydiphthalic acid dianhydride (ODPA), 50.05 g of 4′-diaminodiphenylether (p-DDE) are added. An insulated wire in Example 5 is produced by the same steps as the insulated wire in Example 1 while using the insulating varnish in Example 5.

### Example 6

An insulating varnish in Example 6 is synthesized as in Example 1 except that in the first reaction step. 62.6 g of bicyclo(2,2,2)octane-2,3,5,6-tetracarboxylic acid dianhydride (BTA-H) and 178.9 g of 3,3′-dimethyl-4,4′-diaminodicyclohexylmethane (DMHM) are added and in the second reaction step, 232.7 g of 4,4′-oxydiphthalic acid dianhydride (ODPA), 73.1 g of 1,4-bis(4-aminophenoxy)benzene (TPE-Q) are added. An insulated wire in Example 6 is produced by the same steps as the insulated wire in Example 1 while using the insulating varnish in Example 6.

### Comparative Example 1

An insulating varnish in Comparative Example 1 is synthesized as below.

First, an Allihn condenser tube with a trap equipped with a silicone stop cock is attached to a 51 three-necked separable flask with a stirrer. Then, 310.2 g of 4,4′-oxydiphthalic acid dianhydride (ODPA, MW=310.21), 200.2 g of 4,4′-diaminodiphenylether (p-DDE, MW-200.2) and 2041 g of N-methyl-2-pyrolidone (NMP) are weighed. Then, the weighed materials are put in the flask. Then, stirring at a rotation speed of 180 rpm, they are reacted at room temperature for 5 hours. Then, 20 g of maleic anhydride is further put in the flask, and they are reacted at room temperature for 5 hours. Thereby, a polyimide precursor resin as an insulating varnish in Comparative Example 1 is produced.

Then, as in Example 1, an insulated wire in Comparative Example 1 is produced in which a 31 μm thick insulating covering is formed on the surface of the conductor.

### Comparative Example 2

An insulating varnish in Comparative Example 2 is synthesized as in Comparative Example 1 except that 238.4 g of 3,3′-dimethyl-4,4′-diaminodicyclohexylmethane (DMHM, MW-238.42) is added instead of 4,4′-diaminodiphenylether (p-DDE). An insulated wire in Comparative Example 2 is produced by the same steps as the insulated wire in Example 1 while using the insulating varnish in Comparative Example 2.

### Comparative Example 3

An insulating varnish in Comparative Example 3 is synthesized as in Comparative Example 1 except that 108.1 g of 1,4-phenylenediamine (p-PPD, MW=108.12) is added instead of 4,4′-diaminodiphenylether (p-DDE). An insulated wire in Comparative Example 3 is produced by the same steps as the insulated wire in Example 1 while using the insulating varnish in Comparative Example 3.

### Comparative Example 4

An insulating varnish in Comparative Example 4 is synthesized as below.

First, an Allihn condenser tube with a trap equipped with a silicone stop cock is attached to a 51 three-necked separable flask with a stirrer. Then, 250.2 g of bicyclo(2,2,2)octane-2,3,5,6-tetracarboxylic acid dianhydride (BTA-H, MW=250.2). 200.2 g of 4,4′-diaminodiphenylether (p-DDE, MW=200.2) and 2041 g of N-methyl-2-pyrolidone (NMP, MW=99.1) are weighed. Then, the weighed materials are put in the flask. Then, stirring at a rotation speed of 180 rpm, they are reacted at room temperature for 5 hours. Then, 20 g of maleic anhydride is further put in the flask, and they arc reacted at room temperature for 5 hours. Thereby, a polyimide precursor resin as an insulating varnish in Comparative Example 4 is produced. An insulated wire in Comparative Example 4 is produced by the same steps as the insulated wire in Example 1 while using the insulating varnish in Comparative Example 4.

### Comparative Example 5

An insulating varnish in Comparative Example 5 is synthesized as in Comparative Example 4 except that 238.4 g of 3,3′-dimethyl-4,4′-diaminodicyclohexylmethane (DMHM, MW=238.42) is added instead of 4,4′-diaminodiphenylether (p-DDE). An insulated wire in Comparative Example 5 is produced by the same steps as the insulated wire in Example 1 while using the insulating varnish in Comparative Example 5.

### Comparative Example 6

An insulating varnish in Comparative Example 6 is synthesized as in Comparative Example 4 except that 210.4 g of 4,4′-diaminodicyclohexylmethane (DAHM, MW=210.4) is added instead of 4,4′-diaminodiphenylether (p-DDE). An insulated wire in Comparative Example 6 is produced by the same steps as the insulated wire in Example 1 while using the insulating varnish in Comparative Example 6.

Property Evaluation

The properties of the insulating varnish for insulated wire in Examples 1 to 6 and Comparative Examples 1 to 6 are evaluated in items below. Meanwhile, it is not possible to process the insulating varnish in Comparative Examples 5 and 6 into a film. Therefore, the property evaluation below is made to the insulating varnish in Examples 1 to 6 and Comparative Examples 1 to 4. In Tables 1 and 2 below, an insulating varnish processable into a film is evaluated as ‘Possible’ and an insulating varnish not processable into a film is evaluated as ‘Impossible’.

(1) Flexibility Evaluation (180° Folding Endurance)

A film test strip is prepared by using the insulating varnish in Examples 1 to 6 and Comparative Examples 1 to 4 (while it is impossible to prepare the film test strip by using the insulating varnish in Comparative Examples 5 and 6). The size of the test strip is 2 mm×100 mm. After the test strip is repeatedly folded 180° ten times, it is checked whether it has a crack. If it has a crack, it is evaluated ‘Cracked’ (not passed), and if does not have a crack, it is evaluated ‘Good’ (passed).

(2) Glass-Transition Temperature Evaluation

A 30 mm×5 mm film is prepared by using the insulating varnish in Examples 1 to 6 and Comparative Examples 1 to 4. The elastic modulus of the film is measured at a frequency of 10 Hz and a temperature range of room temperature to 400° C., where a temperature rise rate is 3° C./min, by using a dynamic viscoelasticity measuring instrument (IT Keisoku seigyo Co., Ltd., DVA-200). An inflection point of elasticity measured is determined as a glass-transition temperature.

(3) Copper Adhesion Evaluation

A copper board for copper adhesion evaluation is provided. A 10 mm wide test strip is prepared by coating and baking the insulating varnish in Examples 1 to 6 and Comparative Examples 1 to 4 on the copper board. The adhesion is evaluated by measuring the tensile strength of the test strip by using a TENSILON measuring instrument.

(4) Dielectric Constant Evaluation

A 2 mm×100 mm film test strip is prepared from the insulating varnish in Examples 1 to 6 and Comparative Examples 1 to 4. The dielectric constant at a frequency of 10 GHz is measured by using a cavity resonator (perturbation method) (Agilent Technologies, Inc.).

(5) Dielectric Breakdown Voltage Evaluation

A film for insulated wire is prepared from the insulating varnish in Examples 1 to 6 and Comparative Examples 1 to 4 and sandwiched between 30 mm φ parallel brass plate electrodes. The dielectric breakdown voltage is measured by applying voltage thereto increasing at a rate of 0.5 kV/min starting from 1 kV.

(6) Appearance Evaluation After 400 kV/m Application

An insulated wire is prepared from the insulating varnish in Examples 1 to 6 and Comparative Examples 1 to 4 and sandwiched between 30 mm φ parallel brass plate electrodes. After voltage is applied thereto increasing at a rate of 0.5 kV/min starting from 1 kV up to 12.4 kV, the appearance of the insulating covering is observed by a scanning electron microscope about whether there is a crack. The thickness of the insulating covering is 31 μm. If there is a crack, it is evaluated as ‘Not good (deteriorated)’ (not passed), and if there is not a crack, it is evaluated as ‘Good’ (passed).

The above evaluation results are shown in Tables 1 and 2. For example. Table 1 exhibits the property evaluation results of the insulating varnish and insulated wire in Examples 1 to 6. The additive amount of the group in Tables 1 and 2 is indicated by the number of moles of each material containing the group weighed when producing the insulating varnish.

TABLE 1

| | | Additive amount [mole] | | | | | |
|---|---|---|---|---|---|---|---|
| Structure | | Example 1 | Example 2 | Example 3 | Example 4 | Example 5 | Example 6 |
| X₁ | 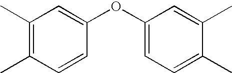 | 0.5 | 0.5 | 0.25 | 0.75 | 0.75 | 0.75 |
| X₂ | 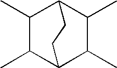 | 0.5 | 0.5 | 0.75 | 0.25 | 0.25 | 0.25 |
| Y₁ | 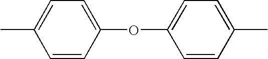 | 0.5 | 0.5 | 0.75 | 0.25 | 0.25 | — |
| | 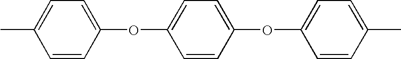 | | — | — | — | — | 0.25 |
| Y₂ | 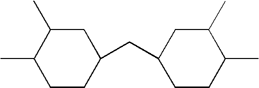 | 0.5 | — | 0.25 | 0.75 | — | 0.75 |
| | 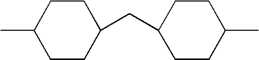 | — | 0.5 | — | — | 0.75 | — |

| | | | | | | |
|---|---|---|---|---|---|---|
| Film formation | Possible | Possible | Possible | Possible | Possible | Possible |
| Film form after 180° folding | Good | Good | Good | Good | Good | Good |
| Glass-transition temperature [° C.] | 242 | 242 | 256 | 232 | 239 | 235 |
| Copper adhesion [N/cm] | 2.0 | 2.0 | 1.5 | 1.6 | 1.8 | 1.6 |
| Dielectric constant | 2.8 | 2.8 | 2.9 | 2.8 | 2.8 | 2.8 |
| Dielectric breakdown voltage [kV/cm] | 5260 | 5420 | 5340 | 5140 | 5400 | 5430 |
| Appearance after applying 400 kV/mm | Good | Good | Good | Good | Good | Good |

Table 2 exhibits the property evaluation results of the insulating varnish and insulated wire in Comparative Examples 1 to 6.

TABLE 1

| | | Additive amount [mole] | | | | | |
|---|---|---|---|---|---|---|---|
| Structure | | Comp Ex 1 | Comp Ex 2 | Comp Ex 3 | Comp Ex 4 | Comp Ex 5 | Comp Ex 6 |
| X₁ | 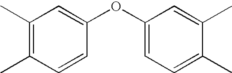 | 1.0 | 1.0 | 1.0 | — | — | — |
| X₂ | 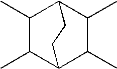 | — | — | — | 1.0 | 1.0 | 1.0 |
| Y₁ | 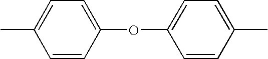 | 1.0 | — | — | 1.0 | — | — |
| | 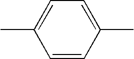 | — | — | 1.0 | — | — | — |
| Y₂ | 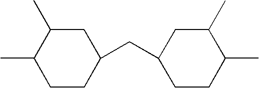 | — | 1.0 | — | — | 1.0 | — |
| | 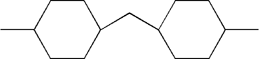 | — | — | — | — | — | 1.0 |

| | | | | | | |
|---|---|---|---|---|---|---|
| Film formation | Possible | Possible | Possible | Possible | Impossible | Impossible |
| Film form after 180 ° folding | Good | Good | Cracked | Cracked | — | — |
| Glass-transition temperature [° C.] | 266 | 199 | 305 | 189 | — | — |
| Copper adhesion [N/cm] | 2.0 | 0.9 | 0.6 | 0.5 | — | — |
| Dielectric constant | 3.0 | 2.7 | 3.2 | 2.7 | — | — |
| Dielectric breakdown voltage [kV/cm] | 4530 | 4620 | 3780 | 4250 | — | — |
| Appearance after applying 400 kV/mm | Not good | Not good | — | Not good | — | — |
| | (deteriorated) | (deteriorated) | | (deteriorated) | | |

Note: Comp Ex = Comparative Example

As described above, it is confirmed that Examples 1 to 6 provide the insulating covering good in all of the property evaluations. The insulating covering in Examples 1 to 6 can reduce the dielectric constant as well as enhancing the heat resistance and the adhesion, so that it can increase the partial discharge inception voltage. Thus, even when a high inverter serge voltage penetrates into the insulated wire with the insulating covering in Examples 1 to 6, the occurrence of partial discharge can be prevented and the deterioration of the insulating covering can be thereby prevented.

Although the invention has been described with respect to the specific embodiments and Examples for complete and clear disclosure, the appended claims are not to be thus limited. In particular, it should be noted that all of the combinations of features as described in the embodiment and Examples are not always needed to solve the problem of the invention.

What is claimed is:

1. An insulating varnish for forming an insulating covering on a conductor, comprising:
a polyimide resin comprising:
a repeat unit represented by a general formula (1): 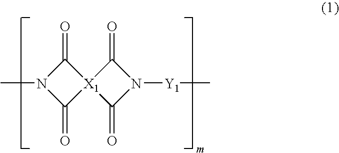
where X₁ comprises a tetravalent aromatic group comprising an aromatic ether structure represented by a formula (3): 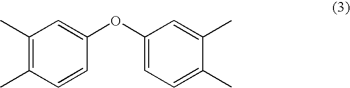
and Y₁ comprises a bivalent aromatic group comprising an aromatic ether structure; and
a repeat unit represented by a general formula (2): 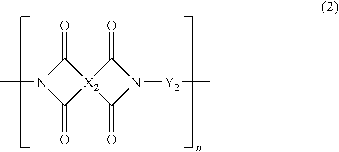
where X₂ comprises a tetravalent alicyclic group and Y₂ comprises a bivalent alicyclic group comprising an alicyclic structure.
wherein, in the general formulas (1) and (2), m and n each are the number of repeat units and a positive integer.

2. The insulating varnish according to claim 1, wherein
X₂ in the general formula (2) comprises a tetravalent alicyclic group selected from groups represented by formulas (4) to (6) below.
Y₁ in the general formula (1) comprises a bivalent aromatic group comprising an aromatic ether structure and represented by a formula (7) below, where 1≦p≦5, and
Y₂ in the general formula (2) comprises a bivalent alicyclic group comprising an alicyclic structure and represented by a formula (8) or (9) below.

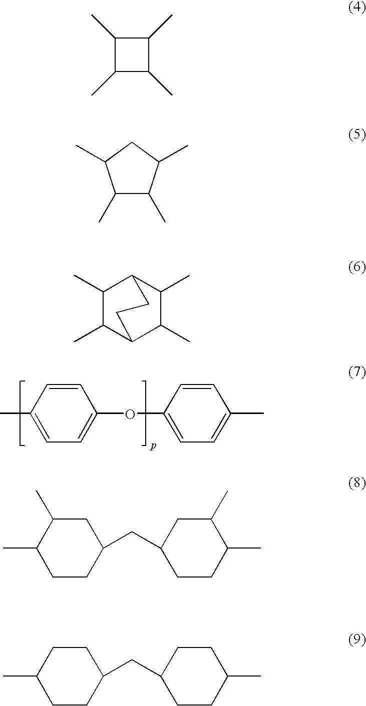

3. The insulating varnish according to claim 2, wherein
the polyimide resin comprises a ratio of the number m of repeat units represented by the general formula (1) to the number n of repeal units represented by the general formula (2): 1/3≦m/n≦3.

4. An insulated wire, comprising:
an insulating covering formed by coating and baking an insulating varnish on a conductor,
wherein the insulating varnish comprises:
a polyimide resin comprising:
a repeat unit represented by a general formula (1): 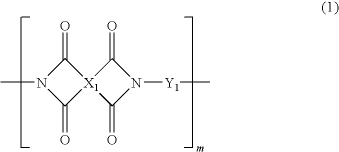
where X₁ comprises a tetravalent aromatic group comprising an aromatic ether structure represented by a formula (3): 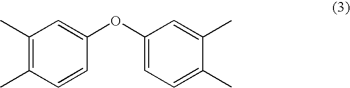
and Y₁ comprises a bivalent aromatic group comprising an aromatic ether structure; and
a repeat unit represented by a general formula (2): 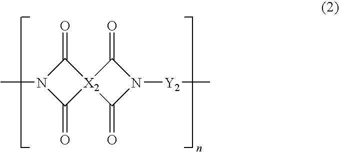
where X₂ comprises a tetravalent alicyclic group and Y₂ comprises a bivalent alicyclic group comprising an alicyclic structure,
wherein, in the general formulas (1) and (2), m and n each are the number of repeat units and a positive integer.

5. The insulated wire according to claim 4, wherein
X₂ in the general formula (2) comprises a tetravalent alicyclic group selected from groups represented by formulas (4) to (6) below,
Y₁ in the general formula (1) comprises a bivalent aromatic group comprising an aromatic ether structure and represented by a formula (7) below, where 1≦p≦5, and
Y₂ in the general formula (2) comprises a bivalent alicyclic group comprising an alicyclic structure and represented by a formula (8) or (9) below.

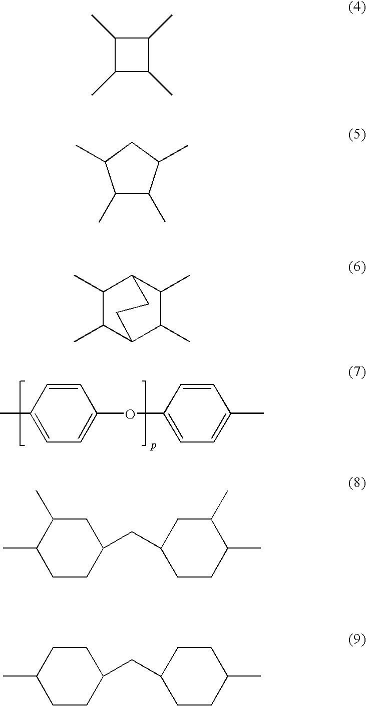

6. The insulated wire according to claim 5, further comprising:
an intermediate insulating covering formed between the conductor and the insulating covering.

7. The insulated wire according to claim 6, wherein
the intermediate insulating covering is formed by coating and baking a silane coupling agent on a surface of the conductor.
